(19) United States
(12) Patent Application Publication
(10) Pub. No.: US 2025/0175861 A1
(43) Pub. Date: May 29, 2025

(54) METHODS AND APPARATUSES FOR AERIAL USER EQUIPMENT SIGNALING OPTIMIZATION

(71) Applicant: LENOVO (BEIJING) LIMITED, Beijing (CN)

(72) Inventors: Jing HAN, Beijing (CN); Haiming WANG, Beijing (CN); Lianhai WU, Beijing (CN); Min XU, Beijing (CN)

(21) Appl. No.: 18/841,135

(22) PCT Filed: Apr. 1, 2022
(86) PCT No.: PCT/CN2022/084869

§ 371 Date: Aug. 23, 2024

(51) Int. Cl. H04W 36/00; H04W 24/10; H04W 76/27

(52) U.S. Cl. CPC H04W 36/0058; H04W 24/10; H04W 76/27

(57) ABSTRACT

Disclosed are methods and apparatuses for signaling overhead optimization for aerial user equipment (e.g., an unmanned aerial vehicle). An embodiment of the subject application provides a UE including: a processor; and a wireless transceiver coupled to the processor, wherein the processor is configured to, with the wireless transceiver: transmit a measurement report in response to that a cell number of a local maintained cell list becomes equal to or less than a report on leave threshold due to removal of at least one neighbor cell fulfilling a leave condition from the local maintained cell list, wherein the processor is enabled with report on leave for multi-cell trigger; and/or transmit flight path available information in at least one message in response to flight path information being available and a preconfigured or configured condition being met.

### TECHNICAL FIELD

The present disclosure generally relates to wireless communications and especially to signaling optimization for aerial user equipments (UEs), e.g., unmanned aerial vehicles (UAVs).

### BACKGROUND OF THE INVENTION

In the near future there will be more and more aerial UEs flying above towns and cities and operating numerous tasks. When these aerial UEs are flying in the air, they have special features that ground devices do not have.

For example, one important characteristic of aerial UEs is that, after aerial UEs flying in the sky, there will be Line of Sight pathloss between aerial UEs and neighbor cells, which has very small pathloss. In this case, not only can the aerial UEs receive strong signals from many neighbor cells, but also result in strong interference to these neighbor cells. To detect such case, a base station (BS) (e.g., an evolved Node B (eNB), a gNB, and etc.) may configure measurement for aerial UE and determine the case according to reported measurement results from the aerial UEs.

On the other hand, the aerial UEs may report flight path plans to a BS (or a network) to assist the network to manage the mobility of the aerial UEs. If flight path information is available, an aerial UE may transmit the flight path available information to the network; after receiving the flight path available information, the network may polling the flight path information via UE information transfer procedures, and the aerial UE may report the flight path information via the UE information transfer procedures. The aerial UEs can indicate flight path available information in RRC signaling e.g. RRCConnectionSetupComplete message, RRCConnectionResumeComplete message, RRCConnectionReconfigurationComplete message, or RRCConnectionReestablishmentComplete message.

### SUMMARY

The present disclosure provides various methods and apparatuses for signaling optimization for aerial UEs, e.g., unmanned aerial vehicles (UAVs).

Some embodiments of the present disclosure provide a user equipment (UE) including: a processor; and a wireless transceiver coupled to the processor, wherein the processor is configured to, with the wireless transceiver: transmit a measurement report in response to that a cell number of a local maintained cell list becomes equal to or less than a report on leave threshold due to removal of at least one neighbor cell fulfilling a leave condition from the local maintained cell list, wherein the processor is enabled with report on leave for multi-cell trigger; and/or transmit flight path available information in at least one message in response to flight path information being available and a preconfigured or configured condition being met. In some embodiments, the first parameter is a target receiving power at the serving BS, and the second parameter is a factor associated with pathloss compensation.

In some embodiments, the report on leave threshold is configured or preconfigured.

In some embodiments, the report on leave threshold is different from or the same as a configured or preconfigured report on entry threshold for report on entry.

In some embodiments, in response to that the at least one neighbor cell fulfills the leave condition, the processor is configured to: check the cell number of the local maintained cell list; in response to that the cell number of the local maintained cell list is equal to or less than the report on leave threshold, remove the at least one neighbor cell from the local maintained cell list; in response to that the cell number of the local maintained cell list is greater than the report on leave threshold: remove the at least one neighbor cell from the local maintained cell list; check the cell number of the local maintained cell list after the removal of the at least one neighbor cell, and transmit the measurement report in response to that the cell number of the local maintained cell list is equal to or less than the report on leave threshold.

In some embodiments, the preconfigured or configured condition includes: the wireless transceiver being connected to non-Evolved Packet Core (EPC) via an eNB; and the processor having received with the wireless transceiver, a radio resource control (RRC) connection setup message, and wherein the at least one message is an RRC connection setup complete message.

In some embodiments, the preconfigured or configured condition further includes that the UE is not a bandwidth reduced low complexity (BL) UE.

In some embodiments, the preconfigured or configured condition includes: the wireless transceiver being connected to a generalized node B (gNB); and the processor having received with the wireless transceiver, an RRC reconfiguration message containing mobility related configuration information from the gNB.

In some embodiments, the mobility related configuration information indicates a handover from the gNB to an eNB in evolved universal terrestrial radio access network (E-UTRAN) NR dual connectivity (EN-DC).

In some embodiments, the at least one message is an RRC reconfiguration complete message transmitted to the gNB via the eNB, and the at least one message is embedded in an E-UTRAN RRC connection reconfiguration complete message transmitted to the eNB.

In some embodiments, the at least one message is an evolved universal terrestrial radio access (E-UTRA) RRC message transmitted to the eNB.

In some embodiments, the mobility related configuration information further indicates conditional primary secondary cell (PSCell) change (CPC), the at least one message is an E-UTRA uplink (UL) information transfer for multiple radio access technology (multi-RAT) dual connectivity (MR-DC) message.

In some embodiments, the mobility related configuration information further indicates RRC connection resume, the at least one message is an E-UTRA RRC connection resume complete message.

In some embodiments, the at least one message is an E-UTRA RRC connection reconfiguration complete message.

In some embodiments, the at least one message includes an RRC reconfiguration complete message transmitted to the gNB via the eNB and an E-UTRA RRC message transmitted to the eNB.

In some embodiments, the preconfigured or configured condition further includes: the mobility related configuration information indicating conditional handover (CHO) or conditional PSCell change (CPC); and the CHO or the CPC being executed, or the at least one message being transmitted to a target cell, and herein the at least one message is an RRC reconfiguration complete message.

In some embodiments, the preconfigured or configured condition further includes: the mobility related configuration information indicating that the RRC reconfiguration message is received via signaling radio bearer 1 (SRB1) rather than SRB3, and the at least one message is an RRC reconfiguration complete message.

In some embodiments, the preconfigured or configured condition includes: the wireless transceiver being connected to a gNB; and the processor receiving with the wireless transceiver, an RRC connection resume message; and herein the at least one message is an RRC connection resume complete message.

In some embodiments, the preconfigured or configured condition further excludes: the RRC connection resume message being received due to radio access network (RAN) based notification area update (RNAU) while the UE is in an RRC inactive state; the processor performing with the wireless transceiver, sidelink (SL) communication or vehicle-to-everything (V2X) communication; and/or the processor performing with the wireless transceiver, small data transmission (SDT).

In some embodiments, the preconfigured or configured condition includes: the processor determining that a serving cell is different from a last serving cell; or the processor determining that the flight path available information has not been transmitted to the serving cell.

In some embodiments, the processor is further configured to transmit with the wireless transceiver, flight path change information in the at least one message in response to the flight path information being changed since the last report of the flight path information.

Some embodiments of the present disclosure provide a method performed by a UE. The method includes transmitting a measurement report in response to that a cell number of a local maintained cell list is equal to a report on leave threshold after removing at least one neighbor cell fulfilling a leave condition from the local maintained cell list, wherein the UE is enabled with report on leave for multi-cell trigger; and/or transmitting flight path available information in at least one message in response to flight path information being available and a preconfigured or configured condition being met.

In some embodiments, the report on leave threshold is configured or preconfigured.

In some embodiments, the report on leave threshold is different from or the same as a configured or preconfigured report on entry threshold for report on entry.

In some embodiments, in response to that the at least one neighbor cell fulfills the leave condition, the method further includes: checking the cell number of the local maintained cell list; in response to that the cell number of the local maintained cell list is equal to or less than the report on leave threshold, removing the at least one neighbor cell from the local maintained cell list; in response to that the cell number of the local maintained cell list is greater than the report on leave threshold: removing the at least one neighbor cell from the local maintained cell list; checking the cell number of the local maintained cell list after the removal of the at least one neighbor cell, and transmitting the measurement report in response to that the cell number of the local maintained cell list is equal to or less than the report on leave threshold.

In some embodiments, the preconfigured or configured condition includes: the UE being connected to EPC via an eNB; and the UE having received with the wireless transceiver, an RRC connection setup message, and wherein the at least one message is an RRC connection setup complete message.

In some embodiments, the preconfigured or configured condition further includes that the UE is not a BL UE.

In some embodiments, the preconfigured or configured condition includes: the UE being connected to a gNB; and the UE having received an RRC reconfiguration message containing mobility related configuration information from the gNB.

In some embodiments, the mobility related configuration information indicates a handover from the gNB to an eNB in EN-DC.

In some embodiments, the at least one message is an RRC reconfiguration complete message transmitted to the gNB via the eNB, and wherein the at least one message is embedded in an E-UTRAN RRC connection reconfiguration complete message transmitted to the eNB.

In some embodiments, the at least one message is an E-UTRA RRC message transmitted to the eNB.

In some embodiments, the mobility related configuration information further indicates CPC, the at least one message is an E-UTRA UL information transfer for MR-DC message.

In some embodiments, the mobility related configuration information further indicates RRC connection resume, the at least one message is an E-UTRA RRC connection resume complete message.

In some embodiments, the at least one message is an E-UTRA RRC connection reconfiguration complete message.

In some embodiments, the at least one message includes: an RRC reconfiguration complete message transmitted to the gNB via the eNB; and an E-UTRA RRC message transmitted to the eNB.

In some embodiments, the preconfigured or configured condition further includes: the mobility related configuration information indicating CHO or CPC; and the CHO or the CPC being executed, or the at least one message being transmitted to a target cell, and wherein the at least one message is an RRC reconfiguration complete message.

In some embodiments, the preconfigured or configured condition further includes: the mobility related configuration information indicating that the RRC reconfiguration message is received via SRB1 rather than SRB3, and the at least one message is an RRC reconfiguration complete message.

In some embodiments, the preconfigured or configured condition includes: the UE being connected to a gNB; and the UE receiving with the wireless transceiver, an RRC connection resume message; and wherein the at least one message is an RRC connection resume complete message.

In some embodiments, the preconfigured or configured condition further excludes: the RRC connection resume message being received due to RNAU while the UE is in an RRC inactive state; the UE performing SL communication or vehicle-to-everything (V2X) communication; and/or the UE performing SDT.

In some embodiments, the preconfigured or configured condition includes: the UE determining that a serving cell is different from a last serving cell; or the UE determining that the flight path available information has not been transmitted to the serving cell.

In some embodiments, the method further includes transmitting flight path change information in the at least one message in response to the flight path information being changed since the last report of the flight path information.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary example about report on leave in prior art.

FIG. 2 illustrates an exemplary method performed by a UE according to some embodiments of the present disclosure.

FIG. 3 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR, new radio), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

As aforementioned, one important characteristic of aerial UEs is that after aerial UEs flying in the sky, there will have Line of Sight pathloss between aerial UEs and neighbor cells, which has very small pathloss. In this case, not only the aerial UEs can receive strong signals from many neighbor cells, but also result in strong interference to neighbor cells. To detect such case, a base station (BS) may configure measurement for aerial UE and determine the case according to reported measurement results from the aerial UEs.

When a neighbor cell fulfils an entry condition or a leave condition of the configured measurement trigger event, the aerial UE may generate a measurement report. Since many neighbor cells can easily fulfill the measurement report trigger condition when the aerial UE flying in the sky, to avoid that aerial UEs frequently trigger great amount of measurement reports, multi-cell measurement trigger enhancement is adopted for the aerial UEs, by which an aerial UEs can be configured to trigger a measurement report if an event condition is met for a configurable number of cells. Events applicable for this enhancement may be A3, A4 and A5. The enhancements help the BS to determine that a UE is flying and/or may be causing or experiencing interference.

However, existing multi-cell measurement trigger enhancement considers only signaling overhead reduction for entry condition, it does not consider signaling overhead for report on leave. This means, if report on leave is enabled, every time that a neighbor cell fulfills the leave condition of the configured measurement trigger event, the aerial UE will trigger a measurement report, which will results in greater signaling overhead.

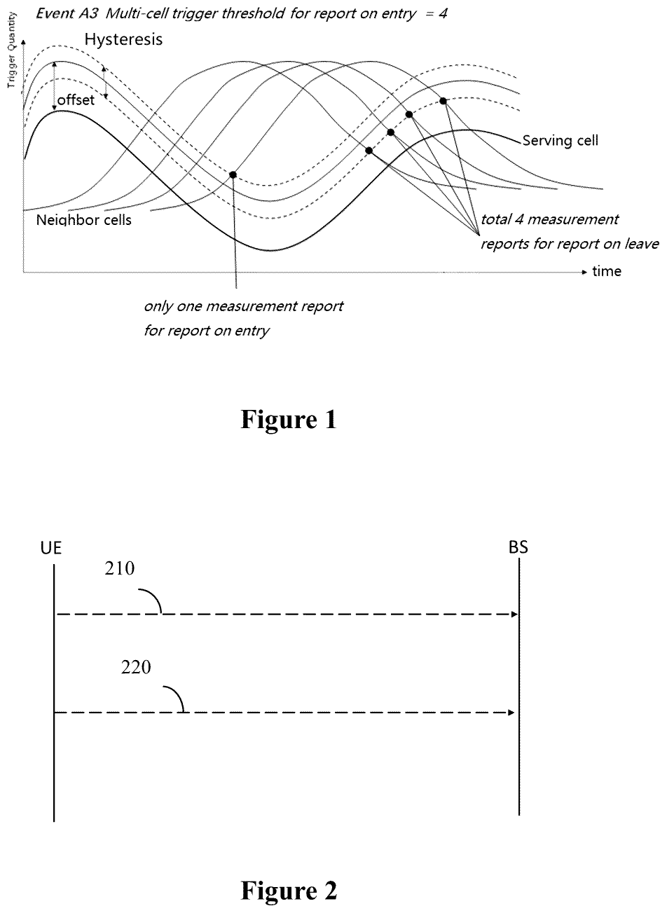

FIG. 1 illustrates an example where the multi-cell trigger enhancement considers report on entry without considering report on leave. Herein, the multi-cell trigger threshold for report on entry is 4, it means that if 4 neighbor cells become meet the entry condition (e.g., A3, neighbor becomes offset better than PCell (primary cell)/primary secondary cell (PSCell)), the aerial UE triggers one measurement report. However, as the multi-cell trigger enhancement does not consider report on leave, then the UE may trigger a measurement report when each of these 4 neighbor cells meets the report on leave condition, therefore total 4 measurement reports for report on leave may be triggered for these 4 neighbor cells.

For flight path report, after receiving the flight path available information from an aerial UE, the network will always poll the flight path information because it does not know whether the aerial UE changes the flight path. Therefore, redundant flight path information will be polled because flight path available information may be sent to the network multiple times.

The present disclosure provides solutions to optimize the signaling overhead for aerial UEs, and especially optimize for signaling regarding flight path report and report on leave, so as to reduce the signaling overhead for the aerial UEs to improve the whole network performance and user experience.

Hereinafter, for simplicity and conciseness, a UE in this disclosure refers to an aerial UE (e.g., a UAV), or a UE may use the technology of the present disclosure.

According to some embodiments of the present disclosure, the UE may maintain a local cell list (e.g., cellsTriggeredList) to record the neighbor cell(s) fulfilling the entry condition after e.g., L3 filtering during TTT of corresponding configured measurement event. Once a neighbor cell fulfills an entry condition, the UE adds the neighbor cell in the local maintained cell list; once a neighbor cell in the local maintained cell list fulfills the leave condition, the UE removes the neighbor cell from the local maintained cell list.

FIG. 2 illustrates an exemplary method 200 performed by a UE for optimizing the signaling overhead according to some embodiments of the present disclosure.

As illustrated in FIG. 2, method 200 includes operation 210 and/or operation 220. In some embodiments, method 200 may perform operation 210. In some embodiments, method 200 may perform operation 220. In some embodiments, method 200 may perform both operation 210 and operation 220.

In operation 210, the UE may transmit a measurement report if a cell number of a local maintained cell list becomes equal to or less than a report on leave threshold (e.g., memberOfTriggeringCellsforLeaving) due to removal of at least one cell fulfilling a leave condition from the local maintained cell list; herein the UE is enabled with report on leave for multi-cell trigger, and the report on leave threshold is a positive integer equal to or greater than 1.

Specifically, in some embodiments, in operation 210, when at least one neighbor cell fulfills the leave condition, the UE checks the cell number of the local maintained cell list. If the cell number of the local maintained cell list is equal to or less than the report on leave threshold, the UE may remove the at least one neighbor cell from the local maintained cell list without transmitting a measurement report for report on leave to the network. If the cell number of the local maintained cell list is greater than the report on leave threshold, the UE may remove the at least one neighbor cell from the local maintained cell list and check the cell number of the local maintained cell list after the removal of the at least one neighbor cell from the local maintained cell list: if the cell number of the local maintained cell list after the removal of the at least one neighbor cell is still greater than the report on leave threshold, the UE will not transmit a measurement report for report on leave; otherwise, the UE will transmit a measurement report for report on leave to the network.

In other words, the UE will not transmit a measurement report each time at least one neighbor cell fulfills the leave condition; instead, the UE will first check the cell number of the neighbor cells left in the local maintained cell list when it removes at least one neighbor cell fulfilling the leave condition from the local maintained cell list. The UE transmits a measurement report for report on leave only when the following condition is fulfilled:
the cell number in the local maintained cell list before removing the neighbor cell fulfilling the leave condition is greater than the report on leave threshold; and
the cell number in the local maintained cell list after removing the neighbor cell fulfilling the leave condition is equal to or smaller than the report on leave threshold.

In some embodiments, the report on leave threshold is configured or preconfigured.

Hereinafter, in the description of this disclosure, “being configured” may be referred to as being configured by a BS or a network via a higher layer signaling, e.g., an RRC signaling or a system information block (SIB); “being pre-configured” may be referred to as being hard-wired into the UE or stored on a subscriber identity module (SIM) or universal subscriber identity module (USIM) card by e.g., a manufacturer.

In some embodiments, the UE is further enabled with report on entry for multi-cell trigger; the UE is configured or preconfigured with a report on entry threshold. The UE will not transmit a measurement report for report on entry each time at least one new neighbor cell fulfills an entry condition; the UE will transmit a measurement when a certain number of neighbor cells fulfill the entry condition; herein the certain number referred to be as a report on entry threshold. Herein, the report on entry threshold is a positive integer equal to or greater than 1.

In some embodiments, the report on leave threshold is different from or the same as the report on entry threshold.

As the UE may not transmit a measurement report each time when it removes a neighbor cell fulfilling the leave condition from the local maintained cell list, the signaling overhead may be reduced.

In operation 220, the UE may transmit the flight path available information (e.g., flightPathInfoAvailable) in at least one message in response to flight path information being available and other conditions being met. In other words, under the restriction of the preconfigured or configured condition, the UE will not frequently transmit the flight path available information; accordingly, the BS will not poll the flight path information frequently; as a result, the signaling overhead may be reduced.

According to some embodiments, in operation 220, the other conditions include:
the UE being connected to a non-EPC (e.g., a 5G core network, 5GC) via an eNB; and
the UE having received an RRC connection setup message (e.g., RRCConnectionSetup), and
   wherein the at least one message is an RRC connection setup complete message (e.g., RRCConnectionSetupComplete).

In some embodiments, the preconfigured or configured condition may further include: the UE being not a BL UE.

For example, a UE is connected to an E-UTRAN which connected to an NR core network; during an RRC establishment procedure, the UE receives an RRC connection setup message from the NR core network. When the UE prepares an RRC connection setup complete message, it may include flight path available information in the RRC connection setup complete message.

According to some embodiments, in operation 220, the other conditions include:
the UE being connected to a gNB; and
the UE having received an RRC reconfiguration message (e.g., RRCReconfiguration) from the gNB during an RRC reconfiguration procedure; herein the RRC reconfiguration message contains mobility related configuration information (e.g., reconfigurationWithSync in spCellConfig of a master cell group (MCG)).
   If the flight path information is available, the UE may transmit the flight path available information via at least one message, wherein the type of the at least one message depends upon the mobility related configuration information and/or a BS where the at least one message is transmitted to.

In some embodiments, in operation 220, the preconfigured or configured condition for repot on leave includes:
the UE being connected to a gNB; and
the UE having received an RRC reconfiguration message (e.g., RRCReconfiguration) containing mobility related configuration information from the gNB during an RRC reconfiguration procedure; herein the mobility related configuration information indicates a handover from the gNB to an eNB in EN-DC.
   After the handover is executed, the UE may transmit the flight path available information via at least one message to the gNB, the eNB in EN-DC, or the both.

For example, in operation 220, the UE may transmit the flight path available information via at least one message to the gNB after the handover from a standalone gNB to the eNB in EN-DC, and the at least one message is an RRC reconfiguration complete message. In this example, first, the UE includes the flight path available information in RRC reconfiguration complete message which is in an E-UTRAN RRC connection reconfiguration complete message (e.g., RRCConnectionReconfigurationComplete within MobilityFromNRCommand); second, the UE transmits the E-UTRAN RRC connection reconfiguration complete message to the eNB in EN-DC; third, the eNB forwards the included RRC reconfiguration complete message to the gNB; fourth, the gNB receives the RRC reconfiguration complete message, and indicates the flight path available information contained in the RRC reconfiguration complete message to the eNB in EN-DC via Xn interface.

For example, in operation 220, the UE may transmit the flight path available information via at least one message to the eNB in EN-DC, and the at least one message is an E-UTRA RRC message; specifically:
if the mobility related configuration information further indicates CPC (i.e., the RRC reconfiguration message is received due to a conditional reconfiguration execution for CPC), the at least one message is an E-UTRA UL information transfer for MR-DC message (e.g., E-UTRA ULInformationTransferMRDC);
if the mobility related configuration information further indicates RRC connection resume (i.e., the received RRC reconfiguration message is included in an E-UTRA RRC connection resume message (e.g., E-UTRA RRCConnectionResume)), the at least one message is an E-UTRA RRC connection resume complete message (e.g., E-UTRA RRCConnectionResumeComplete); otherwise,
the at least one message is an E-UTRA RRC connection reconfiguration complete message (e.g., E-UTRA RRCConnectionReconfigurationComplete).

For example, in operation 220, the UE may transmit a message to each of the gNB and the eNB in EN-DC respectively; in this case, the at least one message includes two messages: one is an RRC reconfiguration complete message including the flight path available information to be transmitted to the gNB via the eNB in EN-DC; the other is an E-UTRA RRC message including the flight path available information to be transmitted to the eNB in EN-DC.

In some embodiments, in operation 220, the other conditions include:
the UE being connected to a gNB;
the UE having received an RRC reconfiguration message (e.g., RRCReconfiguration) containing mobility related configuration information from the gNB, wherein the mobility related configuration information indicates CHO or CPC; and
CHO or CPC being executed, or the at least one message being to be transmitted to a target cell.
   Herein, the at least one message is an RRC reconfiguration complete message (e.g., RRCReconfigurationcomplete).

For example, a UE is connected to a gNB and receives a conditional reconfiguration in an RRC reconfiguration message e.g. for CHO or CPC. After the CHO or CPC is executed, the UE may include the flight path available information in an RRC reconfiguration complete message and send the RRC reconfiguration complete message to a target cell.

In some embodiments, in operation 220, the preconfigured or configured condition for repot on leave includes:
the UE being connected to a gNB; and
the UE having received an RRC reconfiguration message (e.g., RRCReconfiguration) containing mobility related configuration information from the gNB, wherein the mobility related configuration information indicates that the RRC reconfiguration message is received via signaling radio bearer 1 (SRB1) rather than SRB3.
   Herein the at least one message is an RRC reconfiguration complete message (e.g., RRCReconfigurationcomplete).

Specifically, if a UE connected to a gNB receives an RRC reconfiguration message via SRB3, even if the flight path information is available, the UE does not include flight path available information in an RRC reconfiguration complete message. In other words, the UE only includes flight path available information in an RRC reconfiguration complete message when the RRC reconfiguration message is received via SRB1.

In some embodiments, in operation 220, the preconfigured or configured condition includes:
the UE being connected to a gNB; and
the UE receiving an RRC connection resume message (e.g., RRCConnectionResume) during an RRC connection resume procedure.
   Herein, the at least one message is an RRC connection resume complete message (e.g., RRCConnectionResumeComplete).

For example, a UE is connected to a gNB and receives an RRC connection resume message from the gNB. When the UE prepares RRC connection resume complete message content, if the flight path information is available, the UE may include flight path available information in an RRC connection resume complete message to report to the gNB.

In some cases, the UE does not need to always include the flight path available information in an RRC connection resume complete message in the following cases:
if the UE initiates the RRC connection resume procedure for RNAU while the UE is in an RRC_INACTIVE; i.e., the RRC connection resume message is received due to RNAU while the UE is in an RRC inactive state;
if the UE initiates the RRC connection resume procedure for NR SL communication or V2X SL communication; and/or
if the UE initiates the RRC connection resume procedure for SDT.

According to some embodiments of the present disclosure, in operation 220, the preconfigured or configured condition for repot on leave includes:
the UE determining that a serving cell is different from a last serving cell; or
the UE determining that the flight path available information has not been transmitted to the serving cell.
   In other words, if the flight path information is available, the UE transmits the flight path available information only if the flight path available information is never reported to the serving cell before.

For example, an RRC signaling procedure (e.g. an RRC connection establishment procedure, an RRC reconfiguration procedure, an RRC connection re-establishment procedure, an RRC connection resume procedure, and etc.) is initiated between UE and a gNB, and the UE is preparing a corresponding RRC response message (e.g., an RRC setup complete message, an RRC reconfiguration complete message, an RRC reestablishment complete message, or an RRC resume complete message) which is to be transmitted to the gNB. If the UE has available flight path information, UE may include the flight path available information into the RRC response message to be reported to the gNB only if: the serving cell is different from the cell that the flight path available information is reported to in the last time; or this is the first cell that the flight path available information is report to; or it is the first report of the flight path available information.

According to some embodiments of the present disclosure, in operation 220, if the flight path information is available, and the flight path information changes since the last report of the flight path information, the UE may transmit flight path change information in the at least one message.

In some embodiments, in operation 220, if the flight path information is available, and the flight path information changes since the last report of the flight path information to the same cell as the serving cell, the UE may transmit flight path change information in the at least one message to the serving cell.

In some embodiments, in operation 220, if the flight path information is available, and the flight path information changes since the last report of the flight path information, the UE may transmit flight path change information and the flight path available information in the same message.

For example, an RRC signaling procedure (e.g. an RRC connection establishment procedure, an RRC reconfiguration procedure, an RRC connection re-establishment procedure, an RRC connection resume procedure, or etc.) is initiated between a UE and a gNB, and the UE is preparing a corresponding RRC response message (e.g. RRCSetupComplete message, or RRCReconfigurationComplete message, or RRCReestablishmentComplete message, or RRCResumeComplete message) which is to be transmitted to the gNB. If the UE has available flight path information and if the flight path information is different from the last reported flight path information to the serving cell, the UE may include flight path change information in the RRC response message which is to be transmitted to the gNB. In some embodiments, if the gNB has already the flight path information of the UE, the gNB polls the flight path information only after reception of the flight path change information.

It is contemplated that BS performs corresponding methods according to some embodiments of the present disclosure.

According to some embodiments of the present disclosure, if report on leave for multi-cell trigger scheme is enabled for an aerial UE, report on leave is triggered only when the left cell number within a local cell list maintained by the UE becomes equal to or less than a threshold (e.g., the report on leave threshold) after removal of the neighbor cells fulfilling a leave condition from the local maintained cell list. One advantage is that the signaling overhead may be reduced.

According to some embodiments of the present disclosure, if the flight path information is available, the flight path available information is set to be reported under certain conditions; as a result, a BS needs not to frequently poll the flight path information. One advantage is that the signaling overhead may be reduced.

According to some embodiments of the present disclosure, if the flight path information is available, a BS polls the flight path information only if the flight path information is changed since the last report of the flight path information. As a result, the signaling overhead may be reduced.

Furthermore, although the aforementioned solutions of the present disclosure involves technology about a gNB, a eNB, EN-DC, and etc., it is contemplated that along with the communication technology development, the present disclosure teaches how to optimize signaling for aerial UEs in certain aspects for new generations of a BS, a network, a core network, or a new network architecture, as long as not violating the spirit of the present disclosure.

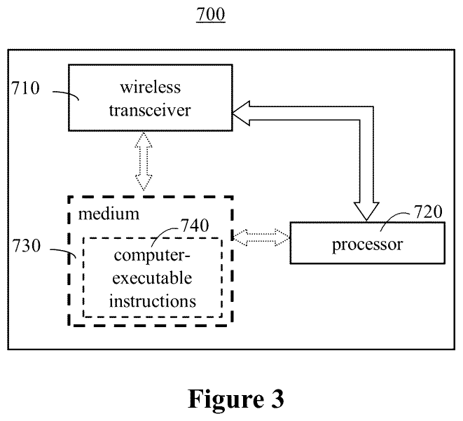

FIG. 3 illustrates a simplified block diagram of an exemplary apparatus 700 according to some embodiments of the present disclosure.

In some embodiments, apparatus 700 may be or include at least a part of a UE or similar device that can use the technology of the present disclosure. In some embodiments, the UE may refer to an aerial UE (e.g., an UAV), or a device having the similar ability, or an unmanned device that can fly in the air and have wireless communication ability.

As shown in FIG. 7, apparatus 700 may include at least wireless transceiver 710 and processor 720, wherein wireless transceiver 710 may be coupled to processor 720. Furthermore, apparatus 700 may include non-transitory computer-readable medium 730 with computer-executable instructions 740 stored thereon, wherein non-transitory computer-readable medium 730 may be coupled to processor 720, and computer-executable instructions 740 may be configured to be executable by processor 720. In some embodiments, wireless transceiver 710, non-transitory computer-readable medium 730, and processor 720 may be coupled to each other via one or more local buses.

Although in FIG. 7, elements such as wireless transceiver 710, non-transitory computer-readable medium 730, and processor 720 are described in the singular, the plural is contemplated unless limitation to the singular is explicitly stated. In certain embodiments of the present disclosure, the apparatus 700 may further include other components for actual usage.

In some embodiments, apparatus 700 is a UE or at least a part of a UE. Processor 720 is configured to cause the apparatus 700 at least to perform, with wireless transceiver 710, any method (e.g., method 200) described above which is performed by a UE according to some embodiments of the present disclosure.

In some embodiments, processor 720 is configured to, with the wireless transceiver: transmit a measurement report in response to that a cell number of a local maintained cell list becomes equal to or less than a report on leave threshold due to removal of at least one cell fulfilling a leave condition from the local maintained cell list, wherein the processor is enabled with report on leave for multi-cell trigger; and/or transmit flight path available information in at least one message in response to flight path information being available and a preconfigured or configured condition being met. Herein, the report on leave threshold is configured or preconfigured.

In some embodiments, the UE will not transmit a measurement report each time at least one neighbor cell fulfills the leave condition; instead, the UE will first check the cell number of the neighbor cells left in the local maintained cell list when it removes at least one neighbor cell fulfilling the leave condition from the local maintained cell list. The UE transmits a measurement report for report on leave only when the following condition is fulfilled:
the cell number in the local maintained cell list before removing the neighbor cell fulfilling the leave condition is greater than the report on leave threshold; and
the cell number in the local maintained cell list after removing the neighbor cell fulfilling the leave condition is equal to or smaller than the report on leave threshold.

In some embodiments, the other conditions include:
the UE being connected to a non-EPC (e.g., a 5G core network, 5GC) via an eNB; and
the UE having received an RRC connection setup message, and
   wherein the at least one message is an RRC connection setup complete message. In some embodiments, the other conditions may further include: the UE being not a BL UE

In some embodiments, the other conditions include:
the UE being connected to a gNB; and
the UE having received an RRC reconfiguration message from the gNB during an RRC reconfiguration procedure; herein the RRC reconfiguration message contains mobility related configuration information.
   If the flight path information is available, the UE may transmit the flight path available information via at least one message, wherein the type of the at least one message depends upon the mobility related configuration information and/or a BS where the at least one message is transmitted to.

In some embodiments, the preconfigured or configured condition includes:
the UE being connected to a gNB; and
the UE having received an RRC reconfiguration message containing mobility related configuration information from the gNB during an RRC reconfiguration procedure; herein the mobility related configuration information indicates a handover from the gNB to an eNB in EN-DC.
   After the handover is executed, the UE may transmit the flight path available information via the at least one message to the gNB, the eNB in EN-DC, or the both.

In some embodiments, the other conditions include:
the UE being connected to a gNB;
the UE having received an RRC reconfiguration message containing mobility related configuration information from the gNB, wherein the mobility related configuration information indicates CHO or CPC; and
CHO or CPC being executed, or the at least one message being to be transmitted to a target cell.
   Herein, the at least one message is an RRC reconfiguration complete message.

In some embodiments, the other conditions include:
the UE being connected to a gNB; and
the UE having received an RRC reconfiguration message containing mobility related configuration information from the gNB, wherein the mobility related configuration information indicates that the RRC reconfiguration message is received via signaling radio bearer 1 (SRB1) rather than SRB3.
   Herein the at least one message is an RRC reconfiguration complete message.

In some embodiments, the other conditions include:
the UE being connected to a gNB; and
the UE receiving an RRC connection resume message during an RRC connection resume procedure.
   Herein, the at least one message is an RRC connection resume complete message.

According to some embodiments of the present disclosure, the other conditions include:
the UE determining that a serving cell is different from a last serving cell; or
the UE determining that the flight path available information has not been transmitted to the serving cell.

According to some embodiments of the present disclosure, if the flight path information is available, and the flight path information changes since the last report of the flight path information, the UE may transmit flight path change information in the at least one message.

In various example embodiments, the processor 720 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 720 may also include at least one other circuitry or element not shown in FIG. 7.

In various example embodiments, the non-transitory computer-readable medium 730 may include at least one storage medium in various forms, such as a volatile memory and/or a non-volatile memory. The volatile memory may include, but is not limited to, for example, a RAM, a cache, and so on. The non-volatile memory may include, but is not limited to, for example, a ROM, a hard disk, a flash memory, and so on. Further, the non-transitory computer-readable medium 730 may include, but is not limited to, an electric, a magnetic, an optical, an electromagnetic, an infrared, or a semiconductor system, apparatus, or device or any combination of the above.

Further, in various example embodiments, the apparatus 700 may also include at least one other circuitry, element, and interface, for example antenna element, and the like.

In various example embodiments, the circuitries, parts, elements, and interfaces in the apparatus 700 may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
transmit a measurement report when a cell number of a locally maintained cell list is equal to or less than a report on leave threshold due to removal of at least one neighbor cell fulfilling a leave condition from the locally maintained cell list, wherein the UE is enabled with report on leave for multi-cell trigger; and
transmit flight path available information in at least one message in response to flight path information being available and a preconfigured or configured condition being met.

2. The UE of claim 1, wherein the report on leave threshold is configured or preconfigured, and the report on leave threshold is different from or the same as a configured or preconfigured report on entry threshold for report on entry.

3. The UE of claim 1, wherein, when at least one neighbor cell fulfills the leave condition, the at least one processor is further configured to cause the UE to:
check the cell number of the local maintained cell list;
in response to that the cell number of the local maintained cell list being equal to or less than the report on leave threshold, remove the at least one neighbor cell from the local maintained cell list; or
in response to that the cell number of the local maintained cell list being greater than the report on leave threshold:
remove the at least one neighbor cell from the local maintained cell list;
check the cell number of the local maintained cell list after the removal of the at least one neighbor cell; and
transmit the measurement report when the cell number of the local maintained cell list is equal to or less than the report on leave threshold.

4. The UE of claim 1, wherein
the preconfigured or configured condition includes:
the UE is connected to non-Evolved Packet Core (EPC) via an evolved Node B (eNB);
the UE is not a bandwidth reduced low complexity (BL) UE; and
wherein, the UE receives a radio resource control (RRC) connection setup message,
and the at least one message is an RRC connection setup complete message.

5. The UE of claim 1, wherein
the preconfigured or configured condition includes:
the UE is connected to a generalized node B (gNB); and
the UE receives an RRC reconfiguration message containing mobility related configuration information from the gNB.

6. The UE of claim 5, wherein the mobility related configuration information indicates a handover from the gNB to an eNB in evolved universal terrestrial radio access network (E-UTRAN) NR dual connectivity (EN-DC).

7. The UE of claim 6, wherein the at least one message is an RRC reconfiguration complete message transmitted to the gNB via the eNB, and wherein the at least one message is embedded in an E-UTRAN RRC connection reconfiguration complete message transmitted to the eNB.

8. The UE of claim 6, wherein the at least one message is an evolved universal terrestrial radio access (E-UTRA) RRC message transmitted to the eNB.

9. The UE of claim 5, wherein the preconfigured or configured condition further includes:
the mobility related configuration information indicating conditional handover (CHO) or conditional PSCell change (CPC); and
the CHO or the CPC being executed, or the at least one message being transmitted to a target cell, and wherein
the at least one message is an RRC reconfiguration complete message.

10. The UE of claim 5, wherein the preconfigured or configured condition further includes: the mobility related configuration information indicating that the RRC reconfiguration message is received via signaling radio bearer 1 (SRB1) instead of SRB3, and the at least one message is an RRC reconfiguration complete message.

11. The UE of claim 1, wherein
the preconfigured or configured condition includes:
the UE is connected to a gNB; and
the UE receives an RRC connection resume message; and
the at least one message is an RRC connection resume complete message.

12. The UE of claim 11, wherein the preconfigured or configured condition further excludes:
the RRC connection resume message being received due to radio access network (RAN) based notification area update (RNAU) while the UE is in an RRC inactive state; or
the UE performs sidelink (SL) communication or vehicle-to-everything (V2X) communication; or
the UE performs small data transmission (SDT).

13. The UE of claim 1, wherein the preconfigured or configured condition includes:
the UE determining that a serving cell is different from a last serving cell; or
the UE determining that the flight path available information has not been transmitted to the serving cell.

14. The UE of claim 1, wherein the at least one processor is further configured to cause the UE to: transmit with the wireless transceiver, flight path change information in the at least one message in response to the flight path information being changed since the last report of the flight path information.

15. A method performed by a user equipment (UE), comprising:
transmitting a measurement report in response to a cell number of a locally maintained cell list is equal to a report on leave threshold after removing at least one neighbor cell fulfilling a leave condition from the locally maintained cell list, wherein the UE is enabled with report on leave for multi-cell trigger; and
transmitting flight path available information in at least one message in response to flight path information being available and a preconfigured or configured condition being met.

16. The method of claim 15, wherein the preconfigured or configured condition includes:
the UE is connected to a generalized node B (gNB); and
the UE receives an RRC reconfiguration message containing mobility related configuration information from the gNB.

17. The method of claim 15, wherein the preconfigured or configured condition includes:
the UE is connected to non-Evolved Packet Core (EPC) via an evolved Node B (eNB);
the UE is not a bandwidth reduced low complexity (BL) UE; and
the UE receives a radio resource control (RRC) connection setup message,
and the at least one message is an RRC connection setup complete message.

18. The method of claim 15, wherein the preconfigured or configured condition includes:
the UE is connected to a gNB; and
the UE receives an RRC connection resume message; and
the at least one message is an RRC connection resume complete message.

19. The method of claim 15, wherein the preconfigured or configured condition includes:
the UE determining that a serving cell is different from a last serving cell; or
the UE determining that the flight path available information has not been transmitted to the serving cell.

20. A processor for wireless communication, comprising:
at least one controller coupled with at least one memory and configured to cause the processor to:
transmit a measurement report when a cell number of a locally maintained cell list is equal to or less than a report on leave threshold due to removal of at least one neighbor cell fulfilling a leave condition from the locally maintained cell list, wherein the processor is enabled with report on leave for multi-cell trigger; and
transmit flight path available information in at least one message in response to flight path information being available and a preconfigured or configured condition being met.
